(19) United States
(12) Patent Application Publication
(10) Pub. No.: US 2024/0411604 A1
(43) Pub. Date: Dec. 12, 2024

(54) RESOURCE ESTIMATION AND MANAGEMENT FOR QUANTUM COMPUTING SYSTEMS

(71) Applicant: Google LLC, Mountain View, CA (US)

(72) Inventors: Tanuj Khattar, Los Angeles, CA (US); Ryan Joseph Babbush, Los Angeles, CA (US); Matthew P. Harrigan, Santa Monica, CA (US)

(21) Appl. No.: 18/736,761

(22) Filed: Jun. 7, 2024

Related U.S. Application Data
(60) Provisional application No. 63/507,145, filed on Jun. 9, 2023.

(51) Int. Cl. G06F 9/50; G06N 10/60

(52) U.S. Cl. CPC G06F 9/5027; G06N 10/60

(57) ABSTRACT

A quantum computing system can execute operations that include obtaining a graph representation of a quantum algorithm to be executed at least in part using the one or more qubits of the quantum computing system and recursively processing the graph representation of the quantum algorithm to determine a resource count associated with the quantum algorithm. Additionally or alternatively, the operations can include obtaining data indicative of a programmer-level representation of a quantum algorithm, the programmer-level representation of the quantum algorithm comprising one or more qubit allocation operations that are qubit-agnostic; and generating an intermediate representation of the quantum algorithm based on the programmer-level representation of the quantum algorithm, wherein generating the intermediate representation of the quantum algorithm comprises associating each of the one or more qubit allocation operations with a qubit of the one or more qubits.

### CROSS-REFERENCE TO RELATED APPLICATIONS

The present application is based upon and claims the right of priority to U.S. Provisional Patent Application No. 63/507,145, filed on Jun. 9, 2023, the disclosure of which is hereby incorporated by reference herein in its entirety for all purposes.

### FIELD

The present disclosure relates generally to quantum computing systems, and more particularly to resource estimation and management for quantum computing systems.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a quantum computing system. The quantum computing system can include one or more classical processors, one or more qubits, and one or more non-transitory, computer-readable media storing instructions that, when implemented, cause the one or more classical processors to perform operations. The operations can include obtaining a graph representation of a quantum algorithm to be executed at least in part using the one or more qubits of the quantum computing system, the graph representation comprising a graph data structure comprising a plurality of nodes and one or more edges between the plurality of nodes. The operations can include recursively processing the graph representation of the quantum algorithm to determine a resource count associated with the quantum algorithm, the resource count indicative of occurrence of one or more quantum resources in the quantum algorithm.

Another example aspect of the present disclosure is directed to a computer-implemented method. The method can include obtaining data indicative a graph representation of a quantum algorithm to be executed at least in part using one or more qubits of a quantum computing system, the graph representation comprising a plurality of nodes and one or more edges between the plurality of nodes. The method can include recursively processing the graph representation of the quantum algorithm to determine a resource count associated with the quantum algorithm, the resource count indicative of occurrence of one or more quantum resources in the quantum algorithm.

Another example aspect of the present disclosure is directed to one or more non-transitory, computer-readable media storing instructions that, when implemented, cause one or more processors to perform operations. The operations can include obtaining data indicative a graph representation of a quantum algorithm to be executed at least in part using one or more qubits of a quantum computing system, the graph representation comprising a plurality of nodes and one or more edges between the plurality of nodes. The operations can include recursively processing the graph representation of the quantum algorithm to determine a resource count associated with the quantum algorithm, the resource count indicative of occurrence of one or more quantum resources in the quantum algorithm.

Another example aspect of the present disclosure is directed to a quantum computing system. The quantum computing system can include one or more classical processors, one or more qubits, and one or more non-transitory, computer-readable media storing instructions that, when implemented, cause the one or more classical processors to perform operations. The operations can include obtaining data indicative of a programmer-level representation of a quantum algorithm, the programmer-level representation of the quantum algorithm comprising one or more qubit allocation operations that are qubit-agnostic. The operations can include generating an intermediate representation of the quantum algorithm based on the programmer-level representation of the quantum algorithm, wherein generating the intermediate representation of the quantum algorithm comprises associating each of the one or more qubit allocation operations with a qubit of the one or more qubits.

Another example aspect of the present disclosure is directed to a computer-implemented method. The method can include obtaining data indicative of a programmer-level representation of a quantum algorithm, the programmer-level representation of the quantum algorithm comprising one or more qubit allocation operations that are qubit-agnostic. The method can include generating an intermediate representation of the quantum algorithm based on the programmer-level representation of the quantum algorithm, wherein generating the intermediate representation of the quantum algorithm comprises associating each of the one or more qubit allocation operations with a qubit of the one or more qubits.

Another example aspect of the present disclosure is directed to one or more non-transitory, computer-readable media storing instructions that, when implemented, cause one or more processors to perform operations. The operations can include obtaining data indicative of a programmer-level representation of a quantum algorithm, the programmer-level representation of the quantum algorithm comprising one or more qubit allocation operations that are qubit-agnostic. The operations can include generating an intermediate representation of the quantum algorithm based on the programmer-level representation of the quantum algorithm, wherein generating the intermediate representation of the quantum algorithm comprises associating each of the one or more qubit allocation operations with a qubit of the one or more qubits.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure.

FIG. 2 depicts an example programmer-level representation of a quantum algorithm according to example embodiments of the present disclosure.

FIG. 3 depicts an example intermediate representation of a quantum algorithm according to example embodiments of the present disclosure.

FIG. 4 depicts an example graph representation of a quantum algorithm according to example embodiments of the present disclosure.

FIG. 5 depicts an example graph representation of a quantum algorithm according to example embodiments of the present disclosure.

FIG. 6 depicts a block diagram of an example quantum operation node according to example embodiments of the present disclosure.

FIG. 7 depicts a flow diagram of an example method for determining a resource count associated with a quantum algorithm according to example embodiments of the present disclosure.

FIG. 8 depicts a flow diagram of an example method for recursively processing a graph representation of a quantum algorithm to determine a resource count associated with the quantum algorithm according to example embodiments of the present disclosure.

FIG. 9 depicts a flow diagram of an example method for converting a programmer-level representation of a quantum algorithm to an intermediate representation of the quantum algorithm according to example embodiments of the present disclosure.

FIG. 10 depicts a block diagram of an example computing system that can be used to implement the systems and methods according to example embodiments of the present disclosure.

### DETAILED DESCRIPTION

Example aspects of the present disclosure are directed to systems and methods for resource estimation and management for quantum computing systems. Some quantum algorithms, such as large quantum algorithms requiring a fault-tolerant quantum computer to execute, can be tedious and/or error-prone to reason about. In classical programming, an algorithm can be represented by a deterministic order of operations. However, there is currently no such analog in quantum programming. Rather, execution of a quantum algorithm can differ greatly based on the quantum states of the underlying quantum variables, which can significantly complicate tasks such as determining resource usage (e.g., a number of qubits) associated with a quantum algorithm.

Example aspects of the present disclosure provide for an improved representation of quantum algorithms in terms of quantum operations. This representation can be amenable to resource estimation and management for quantum algorithms. According to example aspects of the present disclosure, a quantum algorithm can be represented by a hierarchical definition of quantum operations. For instance, a quantum operation can be represented in terms of sub-operations. An abstract base class in a coding language (e.g., Python) can be implemented by sub-classes representing quantum operations. Each sub-class can override methods of the abstract base class that return sub-operations and their connection, which serves to define the parent quantum operation. This representation can be serialized, such as, for example, by a JSON structure or XML code.

This representation can have support for extensible protocols for annotating quantum operations. For instance, the representation can have support for structured and/or extensible data fields for annotating quantum operations with known properties or other attributes. As one example, a quantum operation may be annotated with attributes such as symbols, shapes, names, descriptions, and so on to aid a programmer in the generation of visualizations of quantum algorithms. For example, a given quantum operation may be annotated with a name and a description of what the quantum operation performs when implemented. As another example, a quantum operation may be annotated with attributes such as a tensor representation of the operation's action. As another example, a quantum operation may be annotated with attributes such as a description of the operation's action on purely classical data, if applicable. As another example, a quantum operation may be annotated with attributes such as a description of the operation's analog in other quantum programming languages, SDKs, etc. As another example, a quantum operation may be annotated with attributes such as resource counts. The resource counts can include resource counts that depend on class attributes, symbolic representations, symbolic asymptotic representations, and so on. As another example, a quantum operation may be annotated with additional properties, such as user-defined properties.

This representation can additionally provide support for dependent typing for quantum variables. For instance, a quantum operation can generally take quantum data (e.g., quantum variables) as input and/or produce quantum data as output. According to example aspects of the present disclosure, a type system can be introduced to describe the types of a quantum operation's inputs and outputs. Furthermore, a function signature of a quantum operation can be determined based on the types of the inputs and/or outputs of the quantum operation. In some cases, quantum operations can have predetermined attributes on which the types of the quantum operations can depend. For example, a quantum “bitsize” of a register, representing a number of qubits for the operation, can be supplied by an attribute on the operation.

For instance, a “register” can refer to a defined unit of quantum data. According to example aspects of the present disclosure, a register type can define attributes of a particular register such as, for example, a descriptive name of the register relative to a quantum operation, a number of qubits required to store the quantum data in the register, whether the register is used as input, output, or both, and/or other suitable attributes. As one example, a Controlled Not (CNOT) gate can have two registers, such as a control register and/or a target register. Additional register types can be used such as, for example, multidimensional registers corresponding to arrays of quantum data (e.g., annotated with attributes describing the size of each dimension), registers having different endianness, registers having different integer representations, and/or additional user-defined register types.

Furthermore, example aspects of the present disclosure provide for a quantum algorithm to be represented as a graph representation (e.g. by a graph data structure). One example graph structure for representing quantum algorithms is based on a directed acyclic graph, or DAG. The graph representation (e.g., the graph data structure) can include a plurality of nodes and one or more edges. In some embodiments, the nodes can represent quantum operations (e.g., qubit allocation operations, qubit deallocation operations, quantum gate operations, measurement operations, operations comprising a plurality of sub-operations, etc.). Additionally or alternatively, the edges can represent a (e.g., quantum) data dependency between quantum operations. The use of a graph representation of quantum algorithms can beneficially eliminate avenues for erroneous programming of quantum algorithms. For example, in some embodiments, operations having incompatible register types that are connected in the graph representation can be flagged by a development environment. For instance, in some implementations, an error can be raised prior to execution of the quantum algorithm if nodes corresponding to quantum operations having incompatible typing share an edge. Furthermore, the graph data structure can be used to generate a visualization of the quantum algorithm.

One example aspect of the present disclosure provides a method for determining a resource count associated with a quantum algorithm or quantum program. For instance, the resource count can be a measure of the usage of a particular quantum resource or resources, such as qubits, gates or operations, or other attributes. For example, the resource count can describe the number of times a quantum operation having a particular attribute (e.g., a user-defined or user-selected attribute) appears in a quantum algorithm. As another example, the resource count can describe a number of qubits allocated and/or used by a quantum algorithm.

The method for determining the resource count can be implemented recursively. For instance, for each recursive step at a node, the method can sum the resource counts from any child nodes. The child nodes can have their resource counts determined in the same manner, such that the resource count is recursively propagated through the graph representation of the quantum algorithm. At leaf nodes (e.g., nodes without any child nodes), if the leaf node has or matches a quantum resource that is being counted by the resource count, the resource count can be one (or an equivalent unitary value) for that leaf node and/or for that given quantum resource. In some embodiments, if a node has an attribute that includes a resource count value, that value may be returned as that node's resource count.

In some implementations, each quantum operation in the quantum algorithm may be made immutable and hashable. This provides for the automatic caching of resource counts for quantum operations because the resource count does not change. This, in turn, can provide for resource counting over large algorithms with a significantly improved timescale compared to some existing approaches.

Another example aspect of the present disclosure provides for a qubit memory manager and improved compiling between a programmer-level representation of a quantum algorithm and an intermediate representation of the quantum algorithm. For instance, the programmer-level representation can be the graph representation, which may be represented at a high level with quantum variables representing the flow of data. Explicit memory addresses (e.g., of qubits) may not be included in the programmer-level representation. This programmer-level representation can be compiled to an intermediate representation, such as a quantum assembly language (e.g., Cirq, Qiskit, QASM, etc.). For instance, in the intermediate representation, explicit memory addresses (e.g., of qubits) can be used as the target of quantum operations. Additionally or alternatively, there may be a limited pool of memory addresses (e.g., a limited number of qubits) over which the quantum operations can operate on.

To produce the intermediate representation from the programmer-level representation, the quantum variables and quantum operations of the programmer-level representation can be assigned to actual quantum resources on a quantum computing system. For instance, qubit-agnostic quantum operations assigned to quantum variables can be converted to quantum operations (e.g., quantum gates) that are performed on a particular qubit in a quantum computing system. To reduce quantum computing resource usage (e.g., such that the quantum algorithm is executable with a limited number of qubits), each quantum variable may not be directly converted to a unique qubit or register of qubits. Rather, one or more qubits may be reused for multiple quantum variables at different points during execution of the quantum algorithm. For instance, a qubit may be allocated for a first quantum variable specified by the programmer-level representation. One or more quantum operations associated with the first quantum variable may be performed on the qubit and, once the qubit is no longer used by the quantum algorithm (e.g., after the qubit has been measured), the qubit may be deallocated. The qubit may then be allocated for a second quantum variable and one or more quantum operations associated with the second quantum variable may be performed.

For instance, in some implementations, the programming tasks of defining an algorithm and defining a qubit allocation strategy can be separated by introducing the programmer-level representation including qubit-agnostic allocation operations. At the time that the programmer-level representation is converted into an intermediate representation, the allocation strategy can be controlled with improved knowledge of the complete quantum algorithm, which can provide optimization for different goals or targeted runtimes.

Reallocating qubits introduces a tradeoff between circuit width and circuit depth in the quantum computing system used to implement the quantum algorithm. For instance, circuit width can refer to the total number of unique qubits that are used to implement the quantum algorithm. Additionally or alternatively, circuit depth can refer to a number of quantum operations performed on the qubits used to implement the quantum algorithm. In some cases, the circuit depth can be the highest number of quantum operations performed on any qubit during execution of the quantum algorithm. Additionally or alternatively, the circuit depth can refer to an average number of operations, a median number of operations, or some other circuit-wide metric for the number of quantum operations performed on the qubit. Reallocating qubits can increase circuit depth but decrease circuit width, as more operations can be performed on each qubit but fewer unique qubits are used overall. Generally, a quantum algorithm having a low circuit depth may execute faster than a quantum algorithm having a higher circuit depth. Additionally or alternatively, a quantum algorithm having a low circuit width may use fewer qubits than a quantum algorithm having a higher circuit width.

In some cases, a programmer may wish to influence this tradeoff when generating an intermediate representation from a programmer-level representation. For instance, when the programmer-level representation includes qubit-agnostic quantum operations (e.g., that are instead defined relative to quantum variables), the programmer may not directly control which qubits those quantum variables are implemented on. For example, a programmer-level representation may specify an operation comprising one or more qubit allocation sub-operations; one or more sub-operations (e.g., quantum gate sub-operations, measurement sub-operations, etc.) to perform on the allocated qubit(s); and one or more qubit deallocation sub-operations; without specifying which qubits of a quantum computing system should be allocated or deallocated. This can provide for the programmer to focus the programmer's attention on the design of the quantum algorithm itself when producing the programmer-level representation, which can in turn provide for improved efficiency and reduced error-proneness of quantum programming. However, at the time the programmer-level representation is converted (e.g., compiled) into the intermediate representation, the programmer may wish to optimize the intermediate representation for some resource constraints of the quantum computing system on which the quantum algorithm will execute. For instance, the programmer may wish to tailor the circuit width of the quantum algorithm based on the availability and/or desired usage of resources on the quantum computing system.

Thus, according to example aspects of the present disclosure, systems and methods for generating an intermediate representation of a quantum algorithm and associating each of one or more qubit allocation operations of the intermediate representation with a qubit can provide a programmer with controls for one or more user-specifiable parameters. Selecting the qubit from a previously deallocated qubit or an unused qubit can be based on the user-specifiable parameters. For instance, the user-specifiable parameters can define a selection between quantum circuit width and quantum circuit depth associated with the intermediate representation of the quantum algorithm. As one example, the programmer can be provided with a slider, command-line flag, or other controls to specify the user-specifiable parameters.

Example aspects of the present disclosure can also provide for metaprogramming primitives. These primitives can be higher-level quantum operations that affect the behavior of other quantum operations in a known way. For example, one example metaprogramming primitive is a controlled operation metaprogramming primitive. This primitive can add a control register to the function signature of any given quantum operation such that the operation is active when the control register is indicative of an on status. Another example metaprogramming primitive is a unitary iteration metaprogramming primitive. This primitive adds a selection register to the function signatures of a given list of quantum operations. The operations can be indexed, such that a particular operation is selected when the value of the selection register corresponds to the index of the operation. Other primitives (e.g., user-defined primitives) can also be included. For instance, in some implementations, the present disclosure can provide a library of known (e.g., fault-tolerant) quantum algorithms, subroutines, etc. as primitives to serve as building blocks for subsequent quantum algorithms. The library can include subroutines with defined parameters and attributes, such as, for example, register types, decomposition, resource counts, actions on classical data, tensor representations, and other suitable attributes.

Example aspects of the present disclosure provide a number of technical effects and benefits. For instance, example aspects of the present disclosure can recursively count resources utilized by a graph representation of a quantum algorithm. Obtaining a resource count for a quantum algorithm by recursively parsing a graph representation of the quantum algorithm can provide a computer-implementable manner of obtaining the resource count that exhibits improved efficiency and reduced computing resource usage (e.g., reduced processor cycles, reduced memory usage, etc.) associated with determining the resource count. Furthermore, the graph representation of the quantum algorithm can provide for more definite computation of the resource count compared to an intermediate representation of the quantum algorithm.

Additionally or alternatively, generating an intermediate representation of a quantum algorithm from a programmer-level representation of the quantum algorithm that includes one or more qubit-agnostic qubit allocation operations, where the intermediate representation of the quantum algorithm associates each of the qubit allocation operations with a respective qubit, can provide for improved efficiency and portability of quantum code. For instance, whereas an intermediate representation of the quantum algorithm may be produced based on the qubits available at one quantum computing system, the programmer-level representation can be qubit-agnostic such that the programmer-level representation can be implemented at multiple quantum computing systems, including those having more or fewer qubits than each other. Furthermore, providing the programmer with controls to optimize the qubit allocations for circuit width and/or circuit depth can provide for the intermediate representation of the quantum algorithm compiled from the programmer-level representation to be implemented on any given quantum computing system while taking full advantage of the quantum computing resources (e.g., qubits) available at that quantum computing system. For instance, a programmer-level representation of the quantum algorithm can easily be compiled for a first quantum computing system and a second quantum computing system having differing amounts of quantum resources (e.g., qubits) simply by adjusting the user-specifiable parameters for circuit width and/or circuit depth.

With reference now to the FIGS., example embodiments of the present disclosure will be discussed in further detail. As used here, the use of the term “about” in conjunction with a value refers to within 20% of the value.

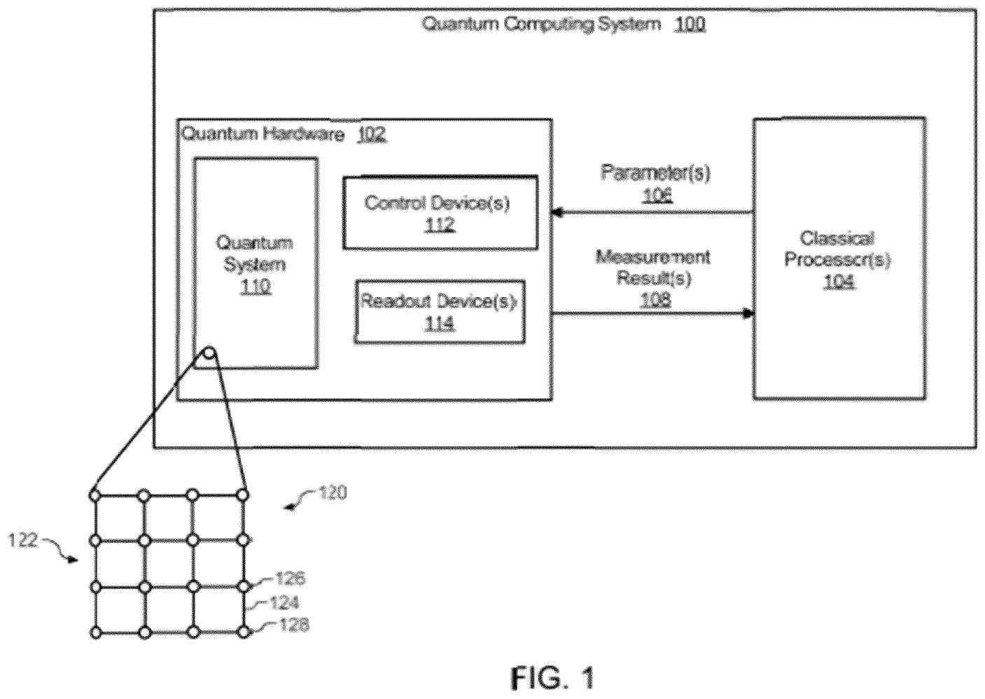

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum system 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

FIG. 1 depicts one example quantum computing system that can be used to implement the methods and operations according to example aspects of the present disclosure. Other quantum computing systems can be used without deviating from the scope of the present disclosure.

The quantum hardware 102 can be programmed to execute a quantum algorithm. For instance, the quantum system 110, the control device(s) 112, and/or the readout device(s) 114 can be configured to implement a quantum instruction set following a quantum algorithm to implement various quantum operations on the quantum hardware 102. According to example aspects of the present disclosure, the quantum algorithm can be programmed at a programmer-level representation, such as a graph representation.

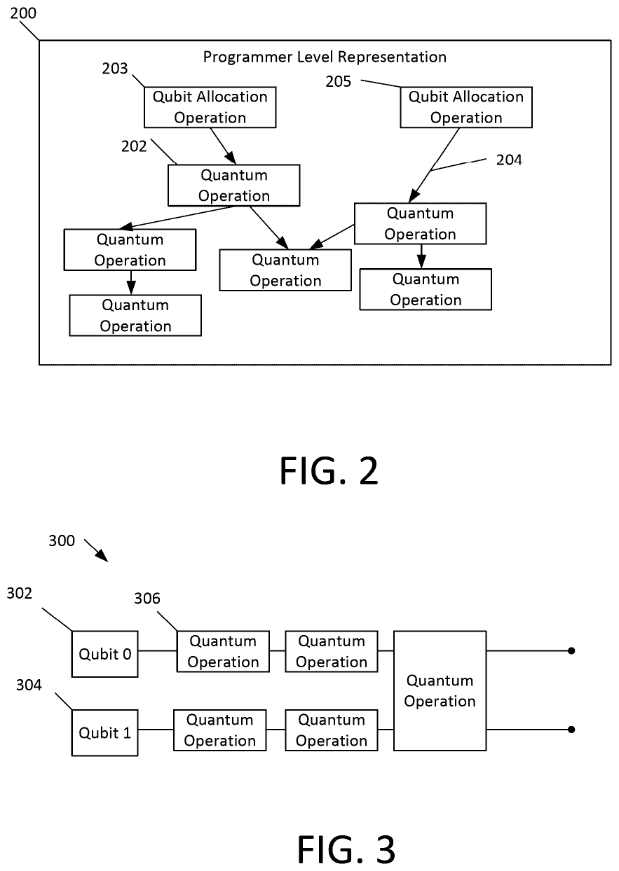

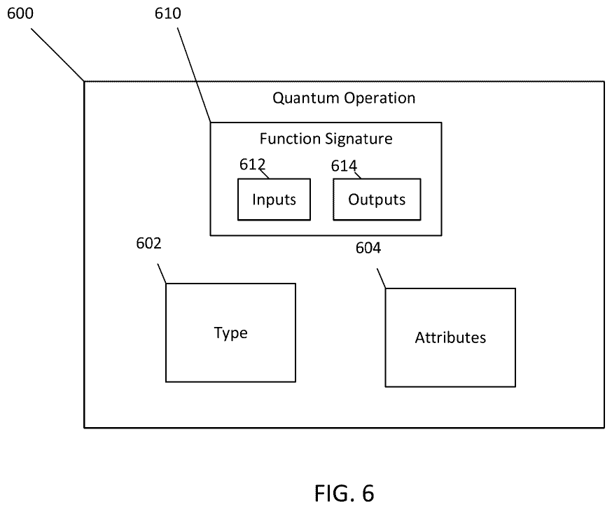

FIG. 2 depicts an example programmer-level representation 200 of a quantum algorithm according to example embodiments of the present disclosure. The programmer-level representation 200 can include one or more quantum operations 202. The quantum operations 202 can depend on one or more qubit allocation operations 203 and 205. For instance, each of the qubit allocation operations 203, 205 can instantiate a unique quantum variable, which are passed as input to the subsequent quantum operations 202. Outputs of the quantum operations 202 are propagated through the programmer-level representation 200 according to data dependencies between the quantum operations, represented by edges 204. An example quantum operation 202 is described further below with respect to FIG. 6

FIG. 3 depicts an example intermediate representation 300 of a quantum algorithm according to example embodiments of the present disclosure. As illustrated, the quantum algorithm can include a first qubit 302 (e.g., qubit 0) and a second qubit 304 (e.g., qubit 1). It should be understood that the quantum algorithm can include any suitable number of qubits. The intermediate representation 300 can be converted from the programmer-level representation 200 of FIG. 2. For instance, the first qubit 302 may correspond to a quantum variable initialized by the qubit allocation operation 203 in the programmer-level representation 200 of FIG. 2. Similarly, the second qubit 304 may correspond to a quantum variable initialized by the qubit allocation operation 205. One or more quantum operations 306 (e.g., quantum gates) may be implemented on or by the qubits 302, 304, corresponding to the quantum operations 202 defined in the programmer-level representation 200. In particular, the qubits 302 and 304 can correspond to physical qubits available in a quantum computing system 300 (e.g., as opposed to quantum variables).

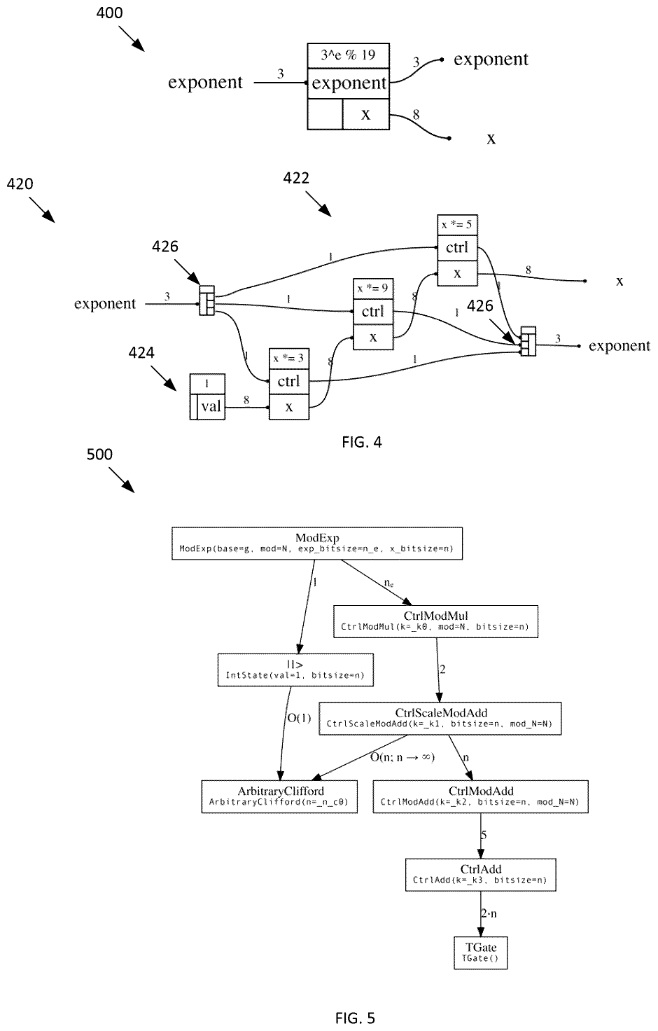

FIG. 4 depicts example graph representations of a quantum algorithm according to example embodiments of the present disclosure. The example of FIG. 4 includes a first graph 400 and a second graph 420. In this particular example, a modular exponentiation operation is illustrated. The first graph 400 can include one high-level operation. The first graph 400 can also include dangling edges corresponding to the quantum inputs and outputs of this subroutine. For instance, the first graph 400 includes an input register named “exponent” and returns the exponent register along with an additional “x” register containing the result of the modular exponentiation. Modular exponentiation by itself can be a classical operation, so the quantum algorithm of the first graph 400 could be annotated with an equivalent classical program to help test the correctness of the functionality. As a quantum subroutine, the inputs can be in superposition and the output x register can contain the result of potentially exponentially-many mathematical operations.

The second graph 420 illustrates a hierarchical decomposition of the first graph 400 showing the internal structure of the quantum operation. The second graph 420 is in particular defined by three sub operations 422 near the middle of the graph 420 (the “ctrl” operations), one qubit register allocation 424 (the “val” block), and two register manipulation operations 426. As illustrated in FIG. 4, the dangling edges representing the subroutine's inputs and outputs for the second graph 420 match the inputs and outputs of the first graph 400. Internal edges show how the outputs of a prior operation are routed into subsequent operations. Edges in FIG. 4 are annotated with the bitsize of the registers that they connect. Other potential attributes on the nodes and edges are not annotated for the purposes of illustration. It should be understood that the edges could be annotated with any suitable attributes as described herein.

In the example of FIG. 4, the three sub-operations are modular multiplication quantum operations and can be decomposed further into yet another subgraph. The allocation block can be considered a primitive operation (to be consumed by the qubit allocation strategy during compilation) and take no execution time. Instead, the allocation block can inform the qubit resources required by the algorithm depicted in the example of FIG. 4. The unlabeled register manipulation blocks 426 can be compiled into zero-quantum-time zero-quantum-space bookkeeping operations and/or removed entirely depending on the classical control system. For instance, these blocks 426 can be included to assist the programmer in reasoning about high-level registers.

In the example of FIG. 4, each operation is depicted as a block with a title on the top cell of each block and a cell for each register. A register can be input-only, output-only or input/output. The nodes in the graph may be these registers (e.g., not necessarily operations) but they can be grouped according to the operation to which they belong. The edges can represent connections between specific inputs and outputs. The data dependencies between operations can be deduced by coarse-graining these graphs.

FIG. 5 depicts an example graph representation 500 of a quantum algorithm according to example embodiments of the present disclosure. In particular, FIG. 5 illustrates an example diagram of the hierarchical resource requirements (e.g., gate counts) for a particular quantum subroutine. The root operation here is the modular exponentiation. In the example of FIG. 4, each classical attribute was specified explicitly (i.e. the exponent bitsize was the concrete number 3). Here, the example of FIG. 5 illustrates symbolic reasoning. Various attributes can be assigned to symbolic representations. For instance, the exponent bitsize is now the symbolic variable n_e instead of a concrete number. Similar to the analysis depicted in FIG. 4, the subroutine is decomposed into two resource-relevant classes of suboperations shown by the directed edges from the root node to its two successors. The edges are annotated with the number of suboperations to build one of the predecessor operations. Subsequent layers represent further decomposition of suboperations until a user-specified base-case is reached. For instance, the leaf operations in the example of FIG. 5 are “TGate” and “ArbitraryClifford,” which may be relevant atomic operations for a superconducting qubit architecture. The example of FIG. 5 also demonstrates the use of “big O” symbolic representation of the mathematical order of the number of required suboperations. For instance, the notation O(n; n->inf) can describe that the number of suboperations grows no faster than linearly (e.g., ignoring multiplicative and added constants). This can provide approximate quantum resource usage for the algorithm without requiring the programmer to explicitly assign resource costs to relatively unimportant portions of the algorithm. This hierarchical decomposition diagram can be further summarized by summing the paths to leaf nodes showing the operation counts for the ultimate leaf nodes as symbolic, explicit, and/or big-O quantities.

FIG. 6 depicts a block diagram of an example quantum operation node 600 according to example embodiments of the present disclosure. For instance, the quantum operation node 600 can be the quantum operations 202 of FIG. 2. The quantum operation node 600 can be a high-level descriptor of a quantum operation that a programmer may use to represent data flow in a programmer-level representation of a quantum algorithm.

The quantum operation node 600 can include a type 602 specifying a type of quantum operation. The type 602 can be any suitable type, such as gate type (e.g., Clifford gate, T gate, CNOT gate, etc.), operation type (e.g., allocation operation, readout operation, etc.) and/or any other suitable type. Additionally or alternatively, the quantum operation node 600 can include one or more attributes 604. The attributes 604 may be generated by a programmer (e.g., as annotations) and/or may be determined or otherwise generated by a computing system. For example, the attributes 604 can correspond to a quantum resource, where a value of the attribute 604 represents the usage of that resource by the quantum operation node 600.

In some implementations, the attributes 604 can include one or more of: symbolic attributes; tensor representation of an action associated with the node; a resource count; an input type; an output type; or a user-defined property. For instance, in some implementations, the attributes 604 can be symbolic attributes representing symbolic resource counts. As another example, the attributes 604 can be or can relate to the function signature 610. It should be understood that the attributes 604 may not necessarily reflect true computing resources. For instance, a programmer may annotate a quantum operation with an arbitrary score or other numerical representation that can be included in a resource count, even if that numerical representation does not directly translate to a usage of computing resources.

Furthermore, the quantum operation node 600 can include a function signature 610. The function signature 610 can provide a high-level description of the inputs 612 and/or outputs 614 of the node 600. For instance, the function signature 610 may be provided as shorthand in a quantum algorithm development environment to assist a programmer in developing a quantum algorithm utilizing the node 600. The inputs 612 and/or outputs 614 can be quantum variables. Furthermore, the inputs 612 and/or outputs 614 can be associated with a quantum variable type. Additionally or alternatively, in some implementations, the inputs 612 and/or outputs 614 can be or can include classical (e.g., binary) data, such as register sizes or other parameters.

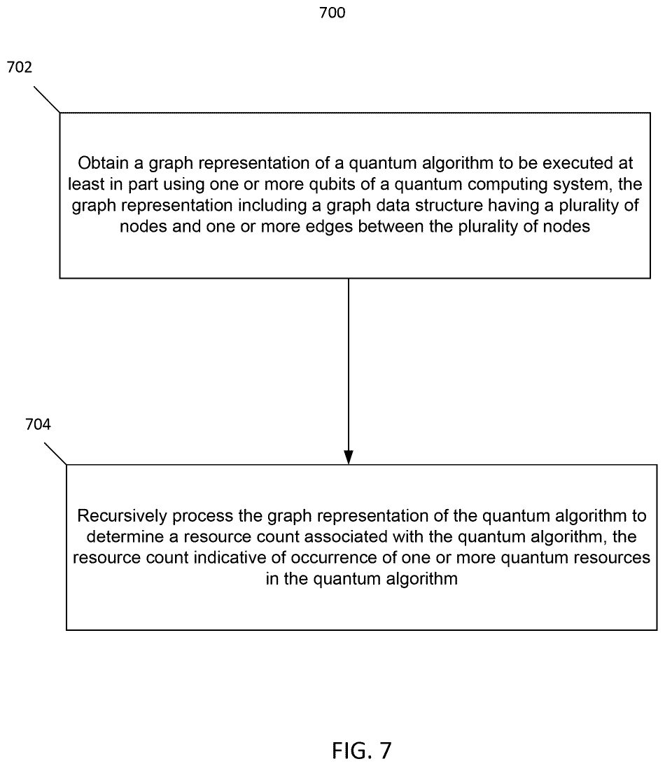

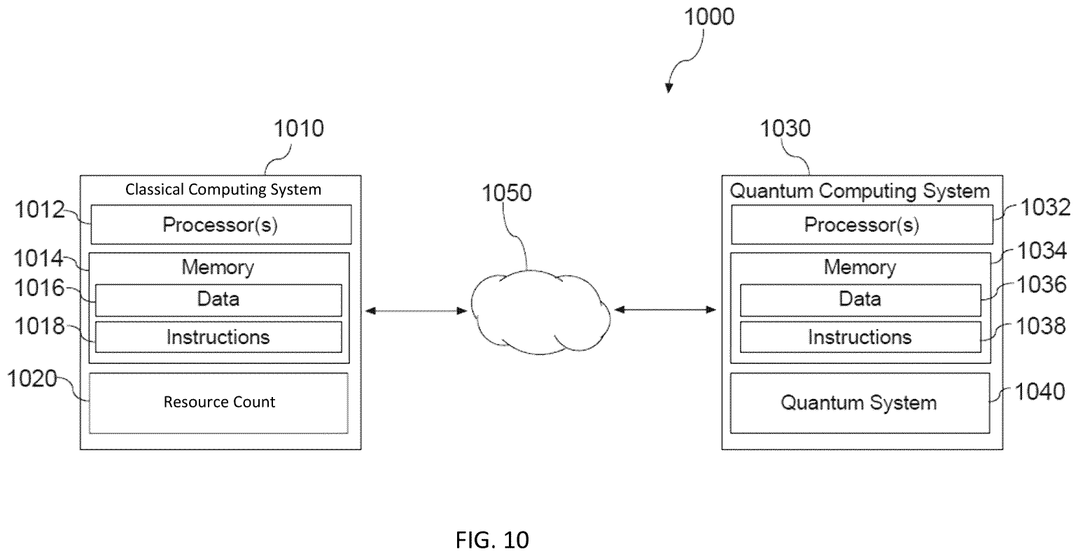

FIG. 7 depicts a flow diagram of an example method 700 for determining a resource count associated with a quantum algorithm according to example embodiments of the present disclosure. The method 700 can be implemented using any suitable system, such as the system 100 shown in FIG. 1 or the system 1000 shown in FIG. 10. FIG. 7 depicts steps performed in a particular order for purposes of illustration and discussion. Those of ordinary skill in the art, using the disclosures provided herein, will understand that various steps of any of the methods described herein can be adapted, expanded, omitted, rearranged, include steps not illustrated, performed simultaneously, and/or modified in various ways without deviating from the scope of the present disclosure. In some example implementations, the methods described herein can be implemented on a quantum computing system including one or more classical processors, one or more qubits, and/or one or one or more non-transitory, computer-readable media storing instructions that, when implemented, cause the one or more classical processors to perform operations, the operations including some or all of the method steps described herein.

At 702, the method 700 can include obtaining data indicative of a graph representation of a quantum algorithm to be executed at least in part using the one or more qubits of the quantum computing system. The graph representation of the quantum algorithm can include data representing execution of the quantum algorithm as a graph data structure indicative of how quantum data is operated on during the execution. For instance, the graph representation can be or can include a graph data structure having a plurality of nodes and one or more edges between the plurality of nodes. In some implementations, the nodes can represent quantum operations, and/or the edges can represent data dependencies between quantum operations. For instance, in some cases, two edges leading into a node can represent two input quantum variables to a quantum operation defined by the node. As another example, one or more edges leading out of a node can represent output quantum variable(s) from the quantum operation defined by the node. Visualization of the quantum algorithm can be generated from the graph representation.

In some implementations, each quantum operation in the quantum algorithm can be immutable and hashable. For instance, each quantum operation can be represented by an unmodifiable hash, or primitive. Once a quantum operation is assigned a hash value, that operation may not be changed without creating a new hash value (e.g., a new primitive). This can provide for automatic caching of resource counts for particular operations. For instance, when a resource count is determined for a particular operation, the value of that resource count can be cached and later pulled by subsequent requests for determining resource counts for that operation, which can significantly reduce computational resource usage associated with programmatically determining the resource count for an operation. This can provide for resource counting on large operations on the order of seconds, whereas some existing systems could take minutes or longer or require error-prone, tedious manual caching annotations.

At 704, the method 700 can include recursively processing the graph representation of the quantum algorithm to determine a resource count associated with the quantum algorithm. The resource count can be indicative of occurrence of one or more quantum resources in the quantum algorithm. The quantum resources can be any suitable resource. One example quantum resource is the number of qubits required by a quantum algorithm. For instance, the resource count can be a qubit count indicative of a number of qubit allocation operations in the quantum algorithm. As another example, the resource count can be a T count indicative of a number of T gates in the quantum algorithm. As another example, the resource count can be a Clifford count indicative of a number of Clifford gates in the quantum algorithm.

In some implementations, one or more attributes can be associated with each of the plurality of nodes and the one or more quantum resources can include or can be represented by the one or more attributes. For instance, the resource count can be indicative of a number of times a node having a given attribute corresponding to a quantum resource (or resources) appears in the graph representation of the quantum algorithm. The attributes may be generated by a programmer (e.g., as annotations) and/or may be determined or otherwise generated by a computing system. As another example, the resource count can include a sum of values specified by an attribute corresponding to a quantum resource across the graph representation. For example, some or all nodes in the graph representation can include an attribute corresponding to a quantum resource, where each value represents the usage of that resource by the quantum operation at that node.

In some implementations, the one or more attributes associated with a node can include one or more of: symbolic attributes; tensor representation of an action associated with the node; a resource count; an input type; an output type; or a user-defined property. For instance, in some implementations, the attributes can be symbolic attributes representing symbolic resource counts. As another example, the attributes can be or can relate to a function signature of the quantum operation of a node. It should be understood that the one or more attributes may not necessarily reflect true computing resources. For instance, a programmer may annotate a quantum operation with an arbitrary score or other numerical representation that can be included in a resource count, even if that numerical representation does not directly translate to a usage of computing resources. For example, a programmer may wish to count the number of times a given quantum operation appears in the quantum algorithm.

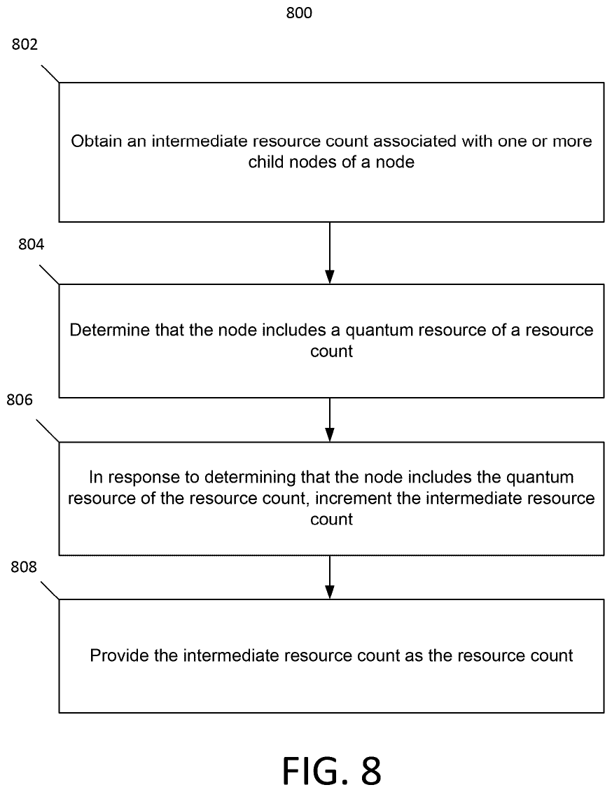

One example method 800 for recursively processing the graph representation of the quantum algorithm to determine the resource count associated with the quantum algorithm is illustrated in FIG. 8. The method 800 can be implemented using any suitable system, such as the system 100 shown in FIG. 1 or the system 1000 shown in FIG. 10. FIG. 8 depicts steps performed in a particular order for purposes of illustration and discussion. Those of ordinary skill in the art, using the disclosures provided herein, will understand that various steps of any of the methods described herein can be adapted, expanded, omitted, rearranged, include steps not illustrated, performed simultaneously, and/or modified in various ways without deviating from the scope of the present disclosure. In some example implementations, the methods described herein can be implemented on a quantum computing system including one or more classical processors, one or more qubits, and/or one or one or more non-transitory, computer-readable media storing instructions that, when implemented, cause the one or more classical processors to perform operations, the operations including some or all of the method steps described herein.

The method 800 can be performed at each of the plurality of nodes in a graph representation of the quantum algorithm. Additionally or alternatively, a starting point for the method 800 (e.g., an initial node) can be selected by a programmer or user. For instance, the programmer or user may wish to determine a resource count only up to a certain node in the quantum algorithm. The node can thus be selected as an initial node for recursive processing. The selected node can be a root node and/or an internal node.

At 802, the method 800 can include obtaining an intermediate resource count associated with one or more child nodes of a node. For instance, for the selected node, the method 800 can include determining a resource count up to the point of each of the child nodes. The resource counts from each of the child nodes can be summed or otherwise aggregated to produce the intermediate resource count. The resource counts from the child nodes can be determined in the same manner (e.g., by the method 800) such that the method 800 is implemented recursively.

In some implementations, if the node is a leaf node, obtaining an intermediate resource count associated with one or more child nodes of the node can include determining that the node is a leaf node; and, in response to determining that the node is a leaf node, obtaining an intermediate resource count of zero. For instance, the system can determine that a node is a leaf node if the node has no child nodes. Because the node has no child nodes, the node can initialize the resource count to zero (or another default value). In subsequent steps, this resource count can be incremented if the node itself matches the resource count.

At 804, the method 800 can include determining that the node includes a quantum resource of the resource count. For instance, a computing system can compare the quantum resource targeted by the resource count to the node and/or the attributes of the node to determine whether the node includes the quantum resource. As one example, if the quantum resource of the resource count is qubit usage (e.g., if the resource count is a qubit count) and the node corresponds to a qubit allocation operation, the node can include the quantum resource of the resource count. As another example, if the resource count is targeting Clifford gates and the node corresponds to a Clifford gate operation, the node can include the quantum resource of the resource count. As yet another example, if the resource count is targeting a particular attribute and/or a particular value of the attribute, the computing system can compare the desired attribute and/or value to the attributes of the node to determine whether the node possesses the desired attribute and/or value. If so, the node can include the quantum resource of the resource count.

In response to determining that the node comprises the quantum resource of the resource count, the method 800 can include, at 806, incrementing the intermediate resource count. For instance, in some implementations, the intermediate resource count can be incremented by a unitary value (e.g., by one) if the node includes the quantum resource. As another example, in some implementations, the intermediate resource count can be incremented by a value specified by an attribute of the node. For example, if the node includes an attribute having a value that may be incremented (e.g., by arithmetic, symbolic addition, etc.) the intermediate resource count may be incremented by that value. As one example, if the resource count is targeting some user-specified parameter having a user-specified value for a node, the intermediate resource count can be incremented by that user-specified value for the node.

At 808, the method 800 can include providing the intermediate resource count as the resource count. For instance, the intermediate resource count can be returned as the resource count (e.g., as a function output). As another example, the intermediate resource count may be passed to a higher-level node in the graph representation such that the higher-level node can use it as an intermediate resource count for a next stage of recursive processing.

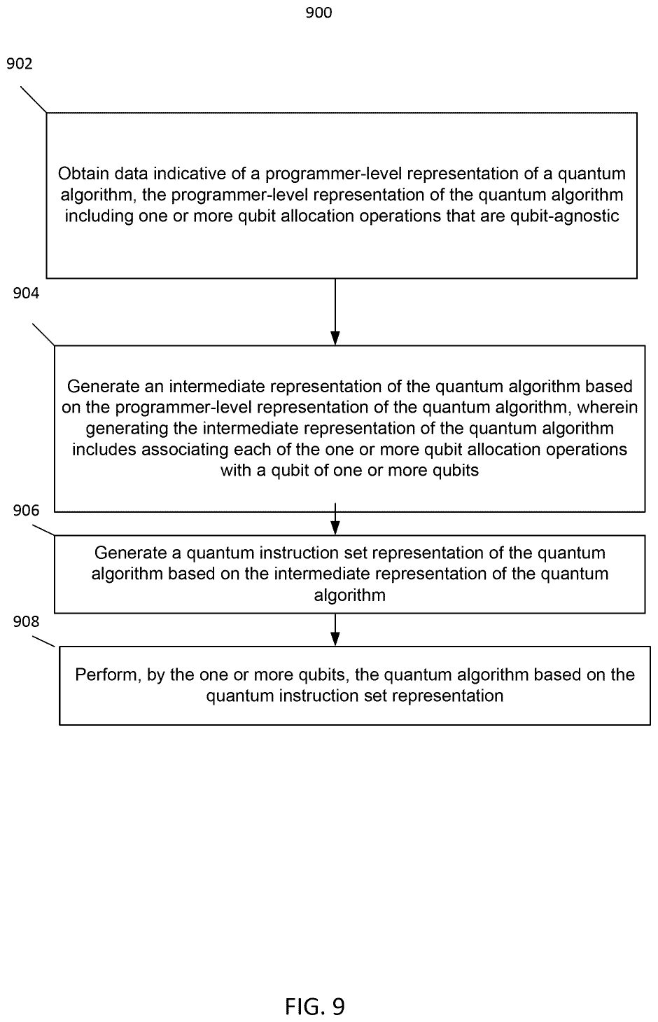

FIG. 9 depicts a flow diagram of an example method 900 for converting a programmer-level representation of a quantum algorithm to an intermediate representation of the quantum algorithm according to example embodiments of the present disclosure. The method 900 can be implemented using any suitable system, such as the system 100 shown in FIG. 1 or the system 1000 shown in FIG. 10. FIG. 9 depicts steps performed in a particular order for purposes of illustration and discussion. Those of ordinary skill in the art, using the disclosures provided herein, will understand that various steps of any of the methods described herein can be adapted, expanded, omitted, rearranged, include steps not illustrated, performed simultaneously, and/or modified in various ways without deviating from the scope of the present disclosure. In some example implementations, the methods described herein can be implemented on a quantum computing system including one or more classical processors, one or more qubits, and/or one or one or more non-transitory, computer-readable media storing instructions that, when implemented, cause the one or more classical processors to perform operations, the operations including some or all of the method steps described herein.

At 902, the method 900 can include obtaining data indicative of a programmer-level representation of a quantum algorithm. The programmer-level representation can be a high level representation of the quantum algorithm, such as a representation that is generated directly by a programmer (e.g., as opposed to being compiled). For instance, in some implementations the programmer-level representation can be or can include a graph representation of the quantum algorithm, such as a graph data structure defining the quantum algorithm. The graph representation (e.g., the graph data structure) can include a plurality of nodes and one or more edges between the plurality of nodes. In some implementations, the plurality of nodes can represent quantum operations and/or the one or more edges between the plurality of nodes can represent data dependencies between the quantum operations.

The plurality of nodes can include one or more qubit allocation operations associated with one or more quantum variables of the quantum algorithm. In particular, the programmer-level representation of the quantum algorithm can include one or more qubit allocation operations that are qubit-agnostic. For instance, the qubit allocation operations may be indicated in the programmer-level representation in a form that does not associate the qubit allocation operations with a particular physical qubit. Rather, the qubit allocation operations may be associated with a placeholder, such as a quantum variable. In this manner, the qubit allocation strategy may be specified at a later point from a point at which the programmer-level representation is generated.

At 904, the method 900 can include generating an intermediate representation of the quantum algorithm based on the programmer-level representation of the quantum algorithm. The intermediate representation of the quantum algorithm can be a representation that is closer to the physical quantum hardware than the programmer-level representation. For instance, in some implementations, the intermediate representation of the quantum algorithm can be a quantum programming language representation of the quantum algorithm. The quantum programming language representation can be defined according to a quantum programming language. For instance, the quantum programming language representation can comply with syntax of a quantum programming language. The quantum programming language can be any suitable quantum programming language. Example quantum programming languages include Python, Qiskit, Q #, and/or Cirq.

In some implementations, generating the intermediate representation of the quantum algorithm can include associating each of the one or more qubit allocation operations with a qubit of the one or more qubits. For instance, the qubit allocation operations can be associated with a particular physical qubit of a quantum computing system instead of, for example, a quantum variable or other placeholder. In this manner, the intermediate representation of the quantum algorithm can reflect the quantum resources of a quantum computing system such that the intermediate representation can be implemented at the quantum computing system.

In some implementations, associating each of the one or more qubit allocation operations with the qubit comprises selecting the qubit from a previously deallocated qubit or an unused qubit. For instance, a computing system can determine whether to reuse a qubit that has already been allocated, measured, and/or deallocated at an earlier point in the quantum algorithm (which may increase the circuit depth of the intermediate representation) and/or utilize an additional qubit (which may increase the circuit width of the intermediate representation). In some implementations, selecting the qubit from a previously deallocated qubit or an unused qubit can be based on one or more user-specifiable parameters. For instance, in some implementations, the one or more user-specifiable parameters can define a selection between quantum circuit width and quantum circuit depth associated with the intermediate representation of the quantum algorithm. As one example, a programmer can be provided with a slider, command-line flag, or other controls to specify the user-specifiable parameters.

In some implementations, the method 900 can further include, at 906, generating a quantum instruction set representation of the quantum algorithm based on the intermediate representation of the quantum algorithm. Additionally or alternatively, the method 900 can further include, at 908, performing, by the one or more qubits, the quantum algorithm based on the quantum instruction set representation. For instance, the quantum instruction set can be a “lowest-level” representation of the quantum algorithm that can be directly implemented by quantum hardware.

In some implementations, the method 900 can further include determining that a quantum variable in the programmer-level representation of the quantum algorithm is erroneously defined and providing an error associated with the intermediate representation of the quantum algorithm. For instance, at the time the intermediate representation is produced and/or at another suitable point in time (e.g., continuously as part of a development kit), the computing system can raise errors associated with erroneously defined quantum variables. The quantum variables may be erroneously defined for various reasons that can represent improper usage of quantum variables and/or qubits. As one example, a quantum variable may be erroneously defined if the quantum variable is assigned a value prior to a qubit allocation operation associated with the quantum variable. As another example, a quantum variable may be erroneously defined if the quantum variable is not read by any quantum operation of the quantum algorithm subsequent to a qubit allocation operation associated with the quantum variable. As another example, a quantum variable is erroneously defined if the quantum variable is read by more than one quantum operation of the quantum algorithm. For instance, in some implementations, a quantum variable may be read from exactly once during execution of a quantum algorithm.

FIG. 10 depicts a block diagram of an example computing system 1000 that can be used to implement the systems and methods according to example embodiments of the present disclosure, such as the system discussed with reference to FIG. 1. The system 1000 includes a calibration system 1010 and a quantum computing system 1030 that are communicatively coupled over a network 1050. One or more aspects of any of the methods described herein can be implemented on the calibration system 1010 and/or the quantum computing system 1030.

The calibration system 1010 can include any type of computing device (e.g., classical computing device). The calibration system 1010 includes one or more processors 1012 and a memory 1014. The one or more processors 1012 can include any suitable processing device (e.g., a processor core, a microprocessor, an ASIC, a FPGA, a controller, a microcontroller, etc.) and can be one processor or a plurality of processors that are operatively connected. The memory 1014 can include one or more non-transitory computer-readable storage mediums, such as RAM, ROM, EEPROM, EPROM, flash memory devices, magnetic disks, etc., and combinations thereof. The memory 1014 can store data 1016 (e.g., qubit parameters, measurements, etc.) and instructions 1018 which are executed by the processor 1012 to cause the calibration computing device 1010 to perform operations, such as one or more aspects of any of the method disclosed herein. The calibration system 1010 can be configured to process calibration data 1020 obtained by measuring a state of a quantum system (e.g., quantum system 1040) to determine gate parameters of a model of a composite gate according to example embodiments of the present disclosure.

The quantum computing system 1030 includes one or more processors 1032 and a memory 1034. The one or more processors 1032 can include suitable processing device (e.g., a processor core, a microprocessor, an ASIC, a FPGA, a controller, a microcontroller, etc.) and can be one processor or a plurality of processors that are operatively connected. The memory 1034 can include one or more non-transitory computer-readable storage mediums, such as RAM, ROM, EEPROM, EPROM, flash memory devices, magnetic disks, etc., and combinations thereof. The memory 1034 can store data 1036 and instructions 1038 which are executed by the processor 1032 to cause the quantum computing system 1030 to perform operations, such as implementation of a quantum circuit having one or more quantum gates on a quantum system 1040 having a plurality of qubits and obtaining associated measurements. The quantum computing system 1030 can be similar to the quantum computing system discussed and described with reference to FIG. 1. Other suitable quantum computing systems can be used without deviating from the scope of the present disclosure.

The network 1050 can be any type of communications network, such as a local area network (e.g., intranet), wide area network (e.g., Internet), or some combination thereof and can include any number of wired or wireless links. In general, communication over the network 1050 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qudits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A quantum computing system, comprising:
one or more classical processors;
one or more qubits; and
one or more non-transitory, computer-readable media storing instructions that, when implemented, cause the one or more classical processors to perform operations, the operations comprising:
obtaining a graph representation of a quantum algorithm to be executed at least in part using the one or more qubits of the quantum computing system, the graph representation comprising a graph data structure comprising a plurality of nodes and one or more edges between the plurality of nodes; and
recursively processing the graph representation of the quantum algorithm to determine a resource count associated with the quantum algorithm, the resource count indicative of occurrence of one or more quantum resources in the quantum algorithm.

2. The quantum computing system of claim 1, wherein recursively processing the graph representation of the quantum algorithm to determine the resource count associated with the quantum algorithm comprises, for each node of the plurality of nodes:
obtaining an intermediate resource count associated with one or more child nodes of the node;
determining that the node comprises a quantum resource of the resource count;
in response to determining that the node comprises the quantum resource of the resource count, incrementing the intermediate resource count; and
providing the intermediate resource count as the resource count.

3. The quantum computing system of claim 2, wherein the node is a leaf node, and wherein obtaining an intermediate resource count associated with one or more child nodes of the node comprises:
determining that the node is a leaf node; and
in response to determining that the node is a leaf node, obtaining an intermediate resource count of zero.

4. The quantum computing system of claim 2, wherein the node is a root node.

5. The quantum computing system of claim 2, wherein the node is an internal node.

6. The quantum computing system of claim 2, wherein the node is selected as an initial node for recursive processing.

7. The quantum computing system of claim 1, wherein the plurality of nodes comprise quantum operations and wherein the one or more edges between the plurality of nodes comprise data dependencies between the quantum operations.

8. The quantum computing system of claim 7, wherein each quantum operation in the quantum algorithm is immutable and hashable.

9. The quantum computing system of claim 1, wherein one or more attributes are associated with each of the plurality of nodes; and wherein the one or more quantum resources comprises the one or more attributes.

10. The quantum computing system of claim 9, wherein the one or more attributes associated with a node comprise one or more of: symbolic attributes; tensor representation of an action associated with the node; a resource count; an input type; an output type; or a user-defined property.

11. The quantum computing system of claim 1, wherein the resource count comprises at least one of a T count, a Clifford count, or a qubit count.

12. A computer-implemented method, the method comprising:
obtaining data indicative of a graph representation of a quantum algorithm to be executed at least in part using one or more qubits of a quantum computing system, the graph representation comprising a plurality of nodes and one or more edges between the plurality of nodes; and
recursively processing the graph representation of the quantum algorithm to determine a resource count associated with the quantum algorithm, the resource count indicative of occurrence of one or more quantum resources in the quantum algorithm.

13. The computer-implemented method of claim 12, wherein recursively processing the graph representation of the quantum algorithm to determine the resource count associated with the quantum algorithm comprises, for each node of the plurality of nodes:
obtaining an intermediate resource count associated with one or more child nodes of the node;
determining that the node comprises a quantum resource of the resource count;
in response to determining that the node comprises the quantum resource of the resource count, incrementing the intermediate resource count; and
providing the intermediate resource count as the resource count.

14. The computer-implemented method of claim 13, wherein the node is a leaf node, and wherein obtaining an intermediate resource count associated with one or more child nodes of the node comprises:
determining that the node is a leaf node; and
in response to determining that the node is a leaf node, obtaining an intermediate resource count of zero.

15. The computer-implemented method of claim 13, wherein the node is selected as an initial node for recursive processing.

16. The computer-implemented method of claim 12, wherein the plurality of nodes comprise quantum operations and wherein the one or more edges between the plurality of nodes comprise data dependencies between the quantum operations.

17. The computer-implemented method of claim 12, wherein one or more attributes are associated with each of the plurality of nodes; and wherein the one or more quantum resources comprises the one or more attributes.

18. The computer-implemented method of claim 12, wherein the resource count comprises at least one of a T count, a Clifford count, or a qubit count.

19. One or more non-transitory, computer-readable media storing instructions that, when implemented, cause one or more processors to perform operations comprising:
obtaining data indicative a graph representation of a quantum algorithm to be executed at least in part using one or more qubits of a quantum computing system, the graph representation comprising a plurality of nodes and one or more edges between the plurality of nodes; and
recursively processing the graph representation of the quantum algorithm to determine a resource count associated with the quantum algorithm, the resource count indicative of occurrence of one or more quantum resources in the quantum algorithm.

20. The non-transitory, computer-readable media of claim 19, wherein recursively processing the graph representation of the quantum algorithm to determine the resource count associated with the quantum algorithm comprises, for each node of the plurality of nodes:
obtaining an intermediate resource count associated with one or more child nodes of the node;
determining that the node comprises a quantum resource of the resource count;
in response to determining that the node comprises the quantum resource of the resource count, incrementing the intermediate resource count; and
providing the intermediate resource count as the resource count.
